(19) United States
(12) Patent Application Publication
(10) Pub. No.: US 2017/0071169 A1
(43) Pub. Date: Mar. 16, 2017

(54) DEVICE AND RESPECTIVE CONTROL METHOD FOR CONTROLLING THE ACTIVITIES OF A COLONY OF INSECTS

(71) Applicants: Manuel BENEDETTI, Trento (IT); Mauro MARTINELLI, Trento (IT); Luca IORIATTI, Baselga di Pine --Trento (IT)

(72) Inventors: Manuel BENEDETTI, Trento (IT); Mauro MARTINELLI, Trento (IT); Luca IORIATTI, Baselga di Pine --Trento (IT)

(73) Assignee: Melixa s.r.l., Trento (IT)

(21) Appl. No.: 15/123,569

(22) PCT Filed: Feb. 19, 2015
(86) PCT No.: PCT/IB2015/051259

§ 371 Date: Sep. 2, 2016

(30) Foreign Application Priority Data
Mar. 5, 2014 (IT) VR2014A000054

(51) Int. Cl. A01K 47/06; G01V 3/08

(52) U.S. Cl. CPC A01K 47/06; G01V 3/088

(57) ABSTRACT

A device (D) and a method for controlling the activities of a colony of insects, in particular bees (A) or similar, according to which panel means (1) are adapted to be mounted at the inlet of at least one beehive (Ki) in which said bees (A) live and of electromagnetic sensor means (4,5,5′,7) mounted on said panel means (1), are provided in order to detect conditions of the beehive (Ki) and the passage of said bees (A) from and towards the inside of said beehive (Ki).

The present invention relates to a device and respective control method for controlling the activities of a colony of insects.

In particular, the present invention is advantageously used in the analysis and study of the activities, behaviors and movements of a colony or swarm of insects, preferably bees or similar, to which the following description will make explicit reference without thereby losing its generality, with also the detection of some environmental parameters in correspondence to a specific area in which such insects live and work.

It is universally known that the study of the biological aspects of the bees in natural or artificial hives is always been of great importance in agriculture to understand the state of ecosystems and their future development, due to the crucial role that bees themselves take in pollination and in sexual reproduction of a large part of plants and vegetables.

Nowadays for this reason not only beekeepers and farmers are numerous, but also scholars and scientists observe carefully the behavior of the bees with the aim of analyzing the important environmental consequences resulting from this, even as a function of the impact that these have consequently on man and on the ability to produce foodstuffs.

These analyses are often the result of daily observation methodologies and control over the activities of bees near the hives, and become a very important factor in terms of time and cost, especially in the case of very large regions and very high density of hives.

Furthermore, the various sensor devices, of a mechanical or hydraulic type for weighing and/or counting nowadays used by such methodologies in order facilitate and integrate the visual monitoring of the activities of the bees, are very often inaccurate and incomplete, requiring a constant and complex maintenance, and with a high energy consumption.

Aim of the present invention is therefore to overcome the drawbacks of the prior art highlighted above.

In particular, an aim of the present invention is to provide a control device which is efficient, precise, complete and with a low energy consumption, in order to understand and interpret the activity and behavior of bees at areas and regions where such bees live and feed on.

A further object of the present invention is to provide a control method of the activities of bees, able to permit an optimal interpretation of the activities and the behavior of bees, and also to define and implement a data bank available and usable worldwide for the study and analysis of the impacts on agriculture and food sector in general.

The structural and functional characteristics of the present invention and its advantages compared with known art will be still more clear and evident from the following sub-claims, and in particular through an examination of the following description, with reference to the annexed drawings, which show the schematic of a preferred but not limiting embodiment of a control device, in which:

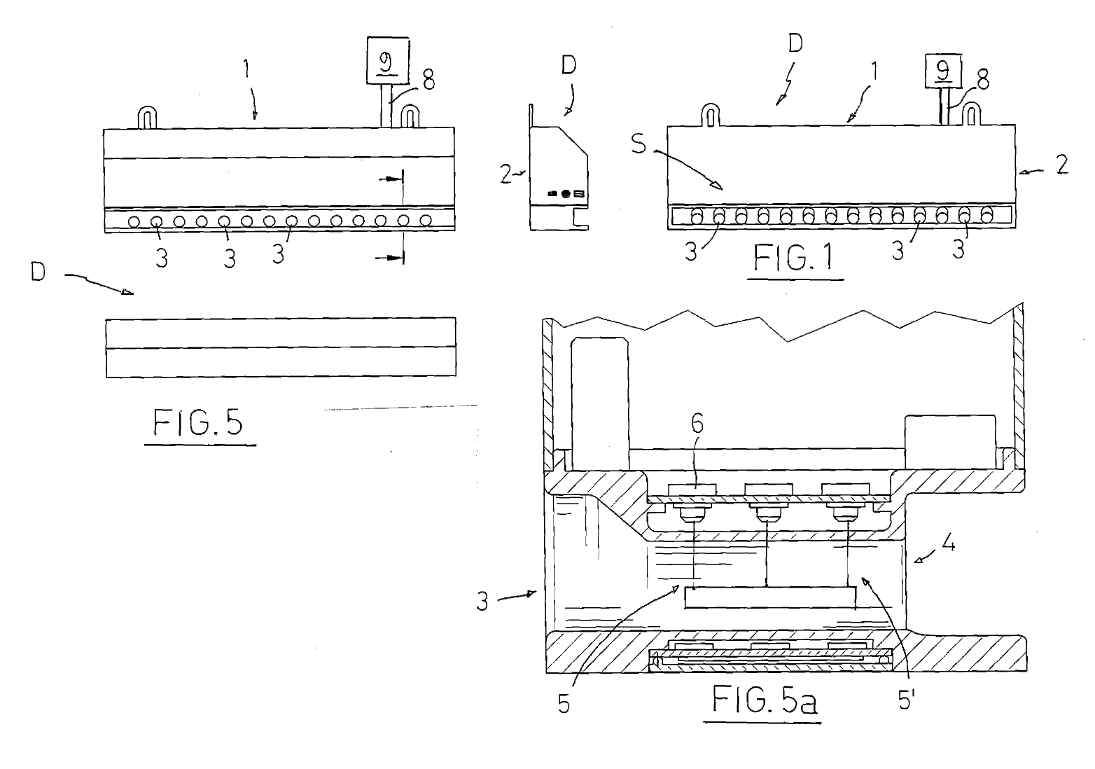

FIG. 1 is a front graphical representation of a preferred embodiment of the referred control device;

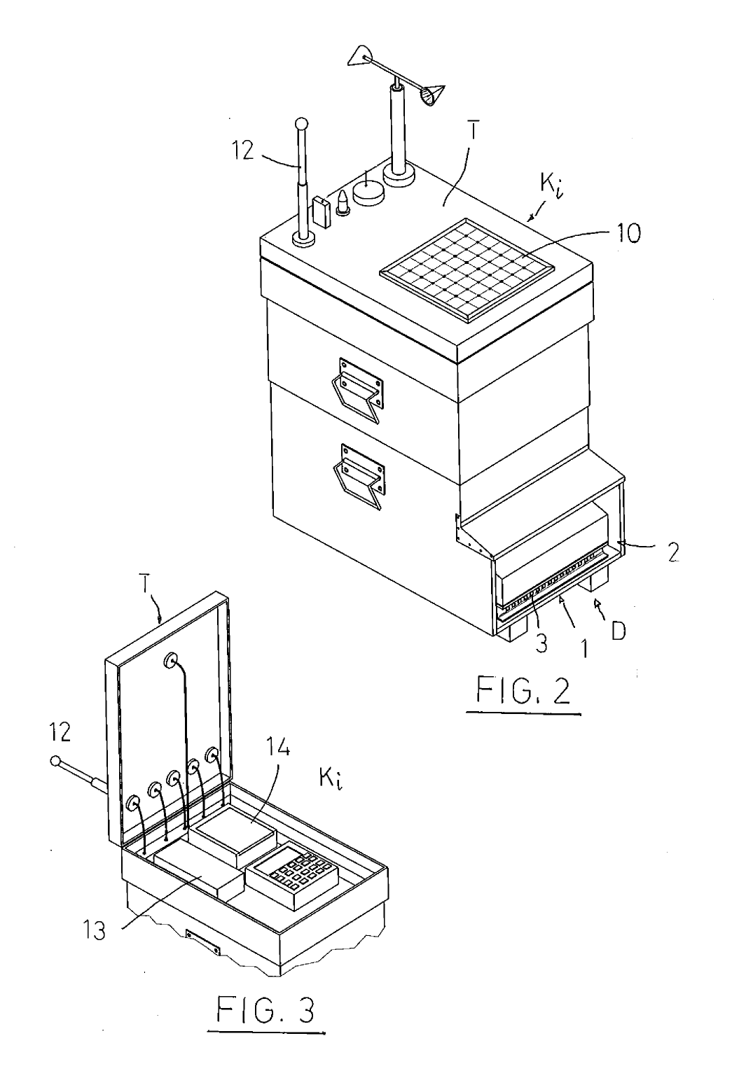

FIG. 2 represents the device of FIG. 1 applied to a beehive;

FIG. 3 is a graphical representation of a group or a community of beehives on which the devices of FIG. 1 are applied;

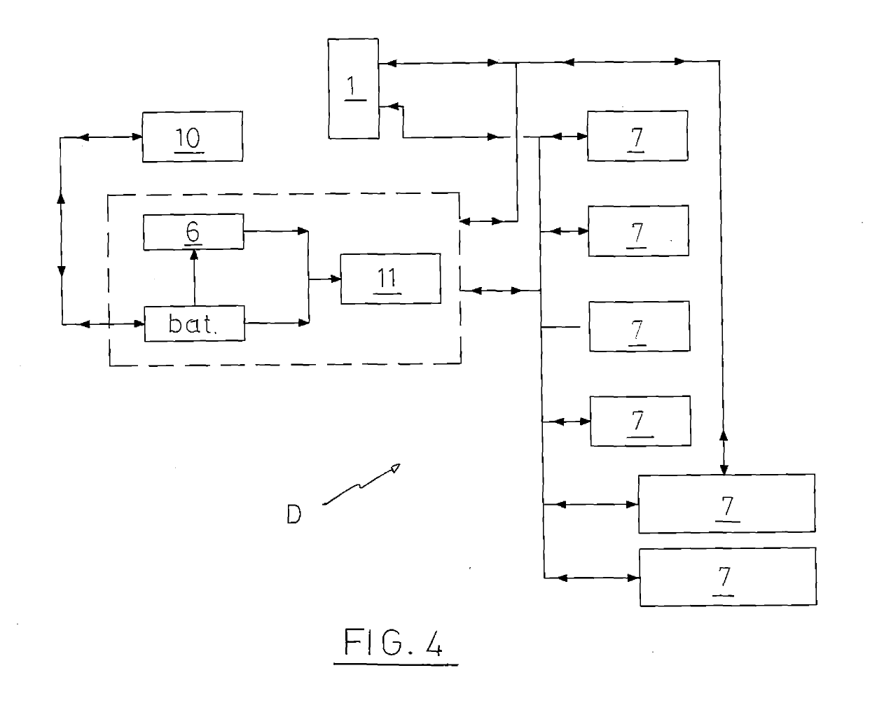

FIGS. 4, 5 and 5a are a structural schematics of the device of FIG. 1; and

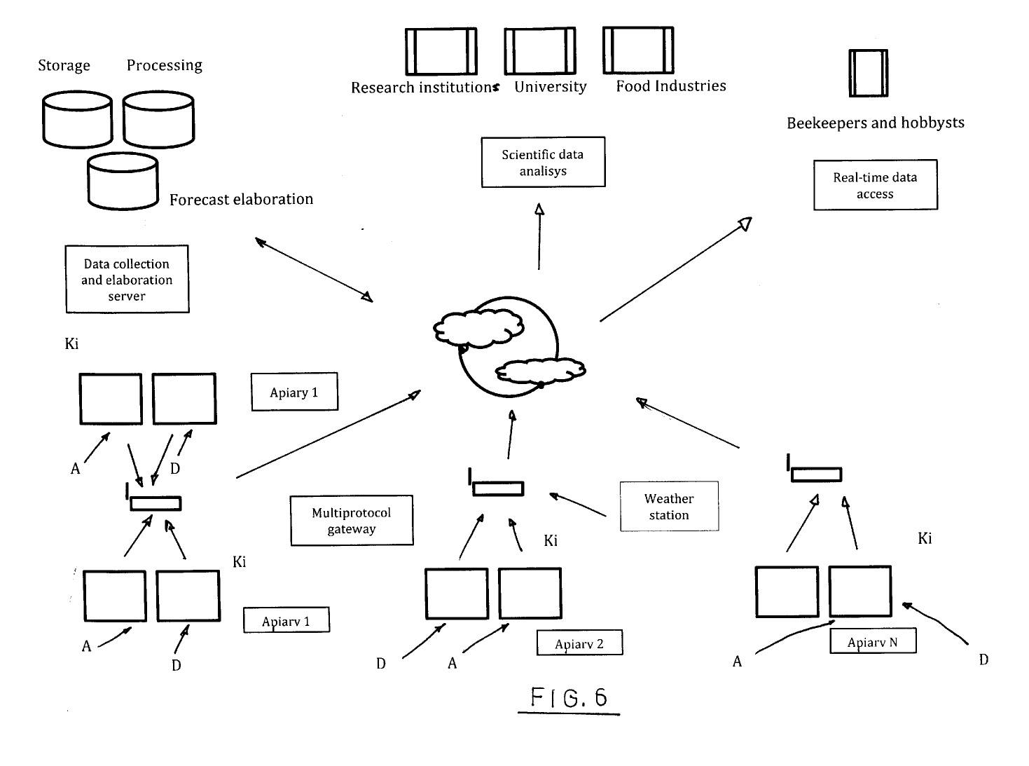

FIG. 6 shows graphically a schematic of the application and of the general functional operation of the detection and control devices actuating the subject method.

With reference to FIGS. 1, 2 and 3, D globally indicates a control device able to detect and control the activities of bees A (FIG. 3) and able to be applied and installed in one or more beehives Ki (four beehives in FIG. 3), where the bees A live, feed on and work.

The beehives Ki can be arranged and also cover large areas or regions of great size.

The device D includes an element or panel 1 for detection and control, which is able to be applied on the front inlet part 2 of each beehive Ki and is provided with a series of holes 3 or cylindrical gates among them and uniformly distributed preferably linear or with a plurality of superimposed rows.

Each hole 3 defines an access hole to the beehive Ki and has a diameter and a length suitably studied and such to permit easy passage of bees A through hole 3, and then the same entry and exit of the bees from the beehive Ki of the bees A themselves.

As shown in FIGS. 5 and 5a, each access hole 3 is provided inside a pair 4 of corresponding proximity sensors 5 and 5′, suitably spaced and electrically connected to each other, so as to define an electromagnetic field G for detection and control, which is crossed by the bees entering and exiting from their beehive, so in both directions of movement, from the beehive Ki during normal daily activities and for the duration of use.

Each pair 4 of sensors 5 and 5′ is also connected to a control and memory unit 6, mounted on the panel 1, which is therefore able to receive and store data related to the activities of movement and passage of the bees A through holes 3. As shown in FIGS. 4 and 5, the panel 1 also comprises, in its part facing the inside of the beehive Ki on which it is mounted, further sensor means 7, and a connection 8 to a feeding group 9.

These sensor means 7 are also connected to the unit 6 and preferably include, but are not limited to, a counting sensor of the colony of bees A living inside the beehive Ki, a sensor for detecting the temperature and humidity inside and/or outside the beehive Ki, a sensor for detecting the intensity of light and/or wind and/or rain at the beehive Ki, a sensor able to detect intrinsic characteristics as for example the swarm of bees A or the weight of the beehive Ki.

It is also possible to use sensors as microphones, sensors or theft protection of the beehive Ki, or sensors able diagnostically control the status of one or more photovoltaic panels 10 or equivalent, mounted for example on the roof T of each beehive Ki, which are able to ensure the necessary energy for the normal functioning of the sensor means 4, 5, 5′, 7 and of the unit 6 mounted on the panel 1, defining the aforementioned feeding assembly (FIGS. 2 and 3). Advantageously, as shown in FIGS. 3, 4 and 6, the unit 6 of the device D is also connected to a module 11 of wireless connection, able to permit the external transmission of all data detected and stored in unit 6, through an antenna 12 located outside the beehive Ki, such as, for example on the roof T of each beehive Ki.

Thus, it is possible to achieve an easy and rapid diffusion anywhere in the world, also via the world wide web or cloud server, through suitable transmission protocols of all data stored in the unit 6 of each beehive Ki and coordinated by an additional coordinating unit 13 (FIG. 3) provided with its own feeding assembly 14, such information being considered essential for analyzing and interpreting the natural environment, such as for example the diffusion of such information data to beekeeper associations (professional or hobbyist), research centers, universities, food industries, data storage centers for the formulation of weather forecast etc. (FIG. 6).

Such data can therefore be easily accessed through PC, Smartphone, Tablet etc. The infrastructure described above has a preferential example of a system architecture, realized according to a distributed shape.

The system can be made in the same way according to other architectures always of the distributed type, by positioning the sensors in other positions of the beehive Ki or even in integrated form in a single device.

The device and its method described above are, in conclusion, optimally and efficiently able to define and implement a database available and accessible worldwide for the fundamental study and analysis of the activities and behavior of bees, also regarding an interpretation and control of the state of agriculture and of ecosystems in general.

1. Device for controlling the activity of a colony of insects, in particular bees or similar, the device comprising panel means adapted to be mounted at the entrance of at least a hive in which said bees live and electromagnetic sensor means mounted on said panel for detecting physical conditions and/or environmental conditions inside and/or outside of said hive, the passage of said bees to and from the interior of said hive and for controlling the intrinsic characteristics of said bees and/or said hive.

2. Device according to claim 1, wherein the said panel means are adapted to be applied on the front inlet of said hive and are provided with a series of cylindrical passage holes for the passage of said bees entering and exiting from said hive.

3. Device according to claim 2, wherein said sensor means comprise movement detecting means of said bees, said movement detecting means being arranged inside of said holes.

4. Device according to claim 1, wherein said sensor means comprise counting means for counting said bees.

5. Device according to claim 1, wherein said sensor means comprise anti-theft security detecting means of said hive.

6. Device according to claim 1, further comprising a central processing unit connected to said sensor means and power supply means for supplying said central unit and said sensor means; said sensor means comprising diagnostic detecting means of said power supply means.

7. Device according to claim 6, wherein said power supply means comprise photovoltaic panels means.

8. Device according to claim 6, wherein said central unit is connected to means for connection and transmission adapted to allow the external transmission of data stored in said unit through antenna means positioned on said hive.

9. Method for controlling the activities of a colony of insects, in particular bees or similar, comprising the step of causing and promoting the passage of said bees through an electromagnetic field for detecting the entrance and exit of said bees from at least a hive in which said bees live, and the steps of controlling the physical conditions and/or environmental conditions inside and/or outside of said hive and of controlling the intrinsic characteristics of said bees and/or of said hive.

10. Method according to claim 9, wherein the said passage comprises the step of crossing by said bees of a series of cylindrical holes in which proximity sensor means are positioned.

11. Method according to claim 9, wherein the said passage comprises the step of counting said bees.
